(19) United States
(12) Patent Application Publication
(10) Pub. No.: US 2013/0252285 A1
(43) Pub. Date: Sep. 26, 2013

(54) IONIC LIQUID PRETREATMENT OF CELLULOSIC BIOMASS: ENZYMATIC HYDROLYSIS AND IONIC LIQUID RECYCLE

(71) Applicants: Harvey W. Blanch, San Francisco, CA (US); Sasisanker Padmanabhan, El Cerrito, CA (US)

(72) Inventors: Harvey W. Blanch, San Francisco, CA (US); Sasisanker Padmanabhan, El Cerrito, CA (US)

(73) Assignee: The Regents of the University of California, Oakland, CA (US)

(21) Appl. No.: 13/824,929

(22) PCT Filed: Sep. 13, 2011
(86) PCT No.: PCT/US11/51439

§ 371 Date: Jun. 3, 2013

Related U.S. Application Data
(60) Provisional application No. 61/385,444, filed on Sep. 22, 2010.

(51) Int. Cl. C08B 1/00

(52) U.S. Cl. CPC C08B 1/003
USPC 435/99; 127/37

(57) ABSTRACT

The present invention relates to compositions and methods of pretreating cellulosic biomass with an ionic liquid. More specifically it relates to pretreating cellulosic biomass in an ionic liquid and adding a salt containing a kosmotropic anion to facilitate separation of precipitated solids, the aqueous phase, and the ionic liquid phase. The ionic liquid phase may be recycled in a subsequent pretreatment step, and the precipitated solids are enzymatically hydrolyzed to produce smaller oligomers of cellulose, cellbiose, and/or glucose. The kosmotropic anion facilitates phase separation where the aqueous phase contains very low concentrations of the ionic liquid.

### CROSS-REFERENCE TO RELATED APPLICATION

This application claims the benefit under 35 U.S.C. §119(e) of U.S. Provisional Application No. 61/385,444, filed Sep. 22, 2010, which is hereby incorporated by reference in the present disclosure in its entirety.

### BACKGROUND

1. Field

The present disclosure relates generally to compositions and methods of pretreating cellulosic biomass with an ionic liquid. More specifically it relates to pretreating cellulosic biomass in an ionic liquid and adding a salt including a kosmotropic anion to facilitate separation of precipitated solids, an aqueous phase, and an ionic liquid phase. The ionic liquid phase may be recycled in a subsequent pretreatment step.

2. Related Art

Lignocellulosic biomass is a potential source of saccharides for conversion to alternative transportation fuels. Such conversion is typically accomplished through production of hexose and pentose sugars from cellulose and hemicellulose as intermediates (Ref. 1). The presence of lignin in the plant cell wall, together with the partially crystalline nature of cellulose fibrils, result in formidable challenges to deconstruction of lignocellulose and depolymerization of its cellulosic content. Several chemical and physical pretreatments have been employed to improve the accessibility of biomass polysaccharides to enzymatic hydrolysis (Ref. 2). These can be classified as follows:

Mechanical

Ball milling and compression milling, which impact biomass or subject it to shear forces, reduce cellulose crystallinity and significantly improve enzymatic hydrolysis. Size reduction below about 1 mm does not provide further improvements in the rate of cellulase action. Because mechanical pretreatment is energy and capital cost intensive, it does not provide a practical pretreatment route.

Dilute Acid and Hydrothermal

Reaction of biomass with water at high temperatures and pressures results in the release of acetic and ferulic acids that are esterified to the pentose sugars of hemicellulose. These acids hydrolyze the hemicellulose and convert the resulting xylose monomers to furfural. The lignin structure is altered and enzymatic accessibility is improved. In the steam-explosion process, rapid decompression of biomass in the presence of saturated steam results in a large increase in biomass surface area, providing the same benefits as those from mechanical and chemical pretreatments. Hot liquid water at high pressure also releases biomass organic acids from the biomass and provides a decrease in cellulose crystallinity. Biomass may be present as a slurry with water flowing through the bed; typical residence times are 15 minutes at 160-220° C., with pressures ranging from 5-25 atm. The use of dilute acids, including HCl, HNO₃, and H₂SO₄, improve the release of lignin from hemicellulose and decrystallization of the cellulose. Dilute acid pretreatment is typically conducted at 140-200° C., with pressures ranging from 4-15 atm, and residence times of 5-30 minutes. Dilute acid pretreatment may be performed in batch with a presoaking period, or employ a continuous flow of acid over the biomass. A dilute stream of pentose sugars results.

Concentrated Acid

Phosphoric acid (85%) at room temperature is able to rapidly solubilize cellulose. The dissolved cellulose can subsequently be precipitated by addition of water to yield readily hydrolyzable amorphous cellulose. Recovery and recycle of the acid are required due to acid cost. Peracetic acid can also remove lignin selectively from lignocellulosics, but cost and safety issues constrain its use.

Bases

Addition of strong bases results in the solubilization of lignin by cleaving the lignin-hemicellulose linkages, and also swells the cellulose. Addition of concentrated NaOH forms the basis of the Kraft pulping process for producing wood pulp and paper. Sodium sulfate also added in Kraft processing results in the cleavage of ether links in lignin by nucleophilic sulfide (S²⁻) or bisulfide (HS⁻) ions. Other base pretreatments include slaked lime (Ca(OH)₂) addition; here low-lignin-content biomass is held for 1-2 hours at 100-120° C. Higher lignin content biomass requires long exposure at 55° C.

Ammonia

Basic ammonia solutions (15%) selectively remove lignin in either batch or percolation reactors. Ammonia fiber expansion (AFEX) employs ammonia at high ratios to biomass (1-2 gm NH₃/gm dry biomass) at 20 atm and 100-120° C. in a process similar to steam explosion. AFEX also provides the benefits of mechanical and chemical pretreatments with the ability to recover the NH₃, which is flashed off in the expansion. Compared to acid pretreatment, the hemicellulose fraction is not significantly solubilized, and inhibitors of subsequent sugar fermentations are not produced. AFEX pretreatment is effective and enzymatic hydrolysis of cellulose is considerably improved relative to dilute acid processing (Ref. 3).

Organosolv

An organic or aqueous/organic solvent mixture, together with an acid catalyst (HCl or H₂SO₄), cleaves hemicellulose and lignin linkages. Solvents that have been studied include methanol, ethanol, acetone, ethylene glycol and tetrahydrofurfuryl alcohol. Above 180° C., acid catalysts are not necessary. Hot ethanol pretreatment was developed primarily for paper production (e.g., the Canadian Alcell® process for hardwoods). The extracted lignin fraction has been examined for its potential to provide co-products such as adhesives and polymers. Solvent recycle is required.

While all the above pretreatment methods have been evaluated for their ability to provide hydrolyzable sources of hemicellulose and cellulose, none is able to sufficiently increase surface area and decrystallize cellulose to permit enzymatic hydrolysis at high solids loadings, short residence times (e.g., less than 24 hours) and low enzyme concentrations. Recently, certain classes of ionic liquids (ILs) have been shown to be good solvents for cellulose and lignocellulose. Ionic liquids based on imidazolium cations (e.g., 1-butyl, 3-methyl imidazolium chloride ([Bmim]Cl) and 1-ethyl-3-methylimidazolium acetate ([Emim][Ac])) can completely dissolve cellulose and lignocellulose at concentrations ranging from five to more than 20 wt %, depending on temperature, nature of the IL, particle size and time (Refs. 4-6). This observation has sparked interest in the use of ILs to dissolve lignocellulosic biomass, because the cellulosic component can be selectively precipitated from the IL phase with an anti-solvent such as water. The resulting material is significantly less crystalline, has a higher surface area and is very susceptible to enzymatic hydrolysis.

Dissolution of Biomass in Ionic Liquids

More than twenty ILs are known to dissolve cellulose (Refs. 7-9). In general, the inter- and intramolecular hydrogen bonds of cellulose are thought to be disrupted, replaced by hydrogen bonding between the IL anion and the carbohydrate hydroxyls (Ref. 10). Consequently, the basicity of the IL anions can alter cellulose solubility. To date, chloride, acetate, formate or alkylphosphonate anions have shown the most promise, because they can effectively hydrogen bond with cellulose. Chloride-containing ionic liquids dissolve pulp cellulose up to 25 wt %, although these solvents require relatively high temperatures and exhibit high viscosities (Ref. 11). Chloride-containing ILs tend to be more viscous than those containing acetate and are more thermally stable than those containing formate. Dissolution of cellulose in [Bmim]Cl is sensitive to water content; typically less than 1% water content is necessary because water competes with the Cl anion for hydrogen bonding with the cellulose hydroxyls. Water may also coordinate with the chloride ions. For commercial cellulose processing, ILs with low toxicity, low melting points and low viscosities are desirable, and imidazolium-based ILs with carboxylic acid or phosphonate anions have received the most attention (Ref. 12).

Both hard and soft woods and lignin can be dissolved in ILs (Refs. 12, 13). A high-throughput screen of ILs for their ability to dissolve microcrystalline cellulose (Avicel, α-cellulose), softwood (spruce, silver fir) and hardwood (beech, chestnut) indicated that, of the ILs tested (1-allyl-3-methylimidazolium-chloride, [Amim]Cl; 1-ethyl-3-methylimidazolium chloride, [Emim]Cl; 1-butyl-3-methylimidazolium chloride, BmimCl; 1,3-dimethylimidazolium-dimethylphosphate, ECOENG; 1-ethyl-3-methylimidazolium acetate, [Emim][Ac]; and 1-butyl-3-methylpyridinium-chloride, BMPYCl), all could dissolve microcrystalline cellulose (Ref. 5). However, only [Amim]Cl and [Emim][Ac] were able to completely dissolve hard and soft woods at 5 wt % concentration. The remaining ILs were able to partially dissolve either wood type. It was suggested that the anions were responsible for disruption of the cellulose, while the π-π interactions of the cation with lignin assisted in lignin solubilization. Dissolution of wood with chloride-containing ILs also requires very low water contents, necessitating almost complete drying of the wood.

Lignin solubility in ILs has been reported (Ref. 14), with 1,3-dimethyl-imidazolium methylsulfate, [Mmim]MeSO₄ and 1-butyl-3-methylimidazolium triflate, [Bmim]CF₃SO₃ able to solubilize over 500 g/Kg, and [Emim][Ac] able to dissolve over 300 g/Kg of lignin. ILs with chloride anions are not as effective in solubilizing lignin, although they exhibit high solubilities for wood flour. Observed lignin solubilities can be attributed to the similar Hildebrand solubility parameters (δ_{H}) of individual ILs and lignin. The design of an ionic liquid based on hydrotropic pulping, a process using aqueous sodium xylenesulfonate, has been recently reported (Ref. 15). [Emim] alkylbenzene sulfonate (ABS), containing isomers of xylenesulfonate, and smaller amounts of ethylbenzenesulfonate, cumenesulfonate and toluenesulfonate, is effective for extraction of lignin from sugarcane bagasse at 170-190° C. and ambient pressures. The bagasse was steam pretreated and the residual moisture (2%) participated in the hydrolytic fragmentation of the lignin polymer. Lignin yield was over 93%.

Enzymatic Hydrolysis of IL-Pretreated Cellulosic Materials

Initial reports on the use of ionic liquids to pretreat cellulose to enhance its susceptibility to enzymatic hydrolysis employed either [Bmim]Cl or [Amim]Cl, using Avicel as a model crystalline material (Refs. 16-17). [Bmim]Cl is hygroscopic and both it and the cellulose must be dried before dissolution. [Amim]Cl is very viscous. Zhao and coworkers (Ref. 18) designed ILs with glycol-substituted cations (Me(OEt)ₙ-Et-Im and Me(OEt)ₙ-Et₃N) and acetate anions. These were able to dissolve up to 10 wt % cellulose and 80 wt % glucose. Anhydrous lipase B from Candida antarctica, immobilized on an acrylic resin, was active in the regioselective transesterification of D-glucose and cellulose in both of these designed IL solvents. When these ILs were used to pretreat crystalline cellulose (dissolution at 110° C. followed by precipitation with water at 0° C.), the regenerated cellulose was significantly decrystallized (60-75% reduction), and higher production rates of reducing sugar production were observed with T. reesei cellulases than with untreated Avicel (Ref. 19). More cellulase was adsorbed on the regenerated Avicel, and the rate of its hydrolysis increased with increasing enzyme concentration. In 6 hours, 95% conversion of Avicel to reducing sugars was reported with 3 mg cellulase per gram Avicel at 50° C.

Dordick and coworkers (Ref. 14) have employed [Emim][Ac] to pretreat maple-wood flour. These authors reported that [Emim][Ac] was able to dissolve over 100 g microcrystalline cellulose per kg IL, but less than 5 g/kg of maple-wood flour. It was proposed that the presence of lignin in the wood flour decreased the solubility of its cellulose. Similarly, Zavrel et al. (Ref. 5) observed that [Emim][Ac] was not able to significantly dissolve silver fir, but was able to dissolve spruce, beech and chestnut chips completely at 5 wt % concentrations. Rogers and coworkers (Ref. 12) have shown complete dissolution of southern yellow pine and red oak at concentrations of 5 wt %. Thus the differences in the ability of [Emim][Ac] to completely dissolve wood chips or wood flour may depend on the chemical nature of the lignin and the cellulose components of the biomass, rather than whether the biomass is a hardwood or softwood. However, the [Emim][Ac] pretreated maple flour that did not dissolve was able to be hydrolyzed by T. reesei cellulases (Ref. 14). The extent of hydrolysis depended on the temperature at which the wood flour was held during pretreatment. At 130° C. with 90 minutes of exposure, 95% release of glucose was observed. The dissolved lignin-containing [Emim][Ac] could be recycled and the lignin later recovered by precipitation with water. This process requires the removal of water from the [Emim][Ac] by evaporation.

Recovery and Recycle of Ionic Liquids

Due to their current high cost, recovery and recycle of ionic liquids is required for commercial use in biomass pretreatment. Most of the cellulosic content of the biomass can be recovered from the IL solution by addition of an anti-solvent such as water. The anti-solvent precipitates cellulose from the solution, with water and IL forming a single phase. Cellulose can be recovered by filtration or centrifugation, and washed to remove excess IL. With water addition however, formation of a gel phase is often observed at high biomass loadings, making cellulose separation difficult. If a water:acetone (1:1, v/v) solution is employed, gel formation is avoided. The dissolved lignin can be subsequently recovered by evaporation of acetone, which precipitates lignin from the IL (e.g., [Emim][Ac], Ref. 12).

An alternative for recovering ionic liquids is provided by their ability to form a biphasic system with the addition of an aqueous solution containing a kosmotropic anion, such as phosphate, carbonate, or sulfate. Rogers et al. first reported the formation of an aqueous biphasic system based on [Bmim]Cl, water and K₃PO₄ (Ref. 20). Subsequently, phase diagrams for a variety of IL/water/salt systems have been described, most of which are based on ILs containing imidazolium cations and chloride anions (Refs. 21-25). The binodal curves for these systems can be fitted to the Merchuk equation, with tie-lines described by the Othmer-Tobias or Bancroft equations (Ref. 25). Recovery of the IL in these systems depends on the concentration of the salt and its position in the Hofmeister series, in order of decreasing recovery K₃PO₄>K₂HPO₄>K₂CO₃. Recovery of the ionic liquid in [Amim]Cl/salt systems was reported to be 96.8% of the IL (Ref. 25).

The role of both anions and cations on the formation of IL-based aqueous biphasic systems was examined by Coutinho and coworkers (Refs. 26-27). The influence of alkyl and hydroxy-alkyl side chains of imidazolium-based ILs on ternary phase diagrams with aqueous K₃PO₄ solutions was reported. The IL anion in these studies was chloride. The IL cation has a significant influence on the behavior of the binodal; increasing alkyl side chain length promotes formation of the biphasic system. A related study on the role of the anion with [Emim] and [Bmim] cations indicated that the ability of the IL to form a biphasic system followed an increasing trend with increasing hydrogen-bond acidity of the IL anion. Thus [Emim] and [Bmim] chloride IL biphasic systems with K₃PO₄ contained less IL in the aqueous phase at a fixed K₃PO₄ concentration than similar acetate-based ILs.

Therefore, what is needed is an ionic liquid pretreatment of biomass or biomass components which facilitates enzymatic hydrolysis of the cellulosic components of the biomass and allows for separation and recycle of the ionic liquid.

### SUMMARY

The present invention provides compositions and methods for the ionic liquid pretreatment of biomass with phase separation and recycle of the ionic liquid. The compositions and methods disclosed herein include use of a kosmotropic anion in aqueous to induce phase separation of the pretreated biomass, aqueous phase, and ionic liquid phase. The presence of the kosmotropic anion results in separation of an aqueous phase with very low concentrations of ionic liquid present, for example, 0-2 wt % ionic liquid present in the aqueous phase.

In some non-limiting variations, the present invention provides compositions including: (a) biomass; (b) an ionic liquid; (c) water; and (d) a salt including a kosmotropic anion selected from phosphate, hydrogenphosphate, sulfate, ethylsulfate, borate, bromide, chloride, acetate, formate, citrate, and mixtures thereof. In other non-limiting variations, the salt further includes a cation selected from one or more of a Group IA metal, a Group IIA metal, a transition metal, and ammonium. In some preferred variations, the cation is selected from one or more of lithium, sodium, potassium, magnesium, calcium, and ammonium. In some preferred variations, the salt is potassium phosphate or potassium hydrogenphosphate.

In some non-limiting variations, the ionic liquid includes an ionic liquid cation selected from optionally substituted imidazolium; optionally substituted pyridinium; optionally substituted pyridazinium; optionally substituted pyrimidinium; optionally substituted pyrazinium; optionally substituted pyrazolium; optionally substituted thiazolium; optionally substituted 1,2,3-triazolium; optionally substituted 1,2,4-triazolium; optionally substituted oxazolium; optionally substituted isoquinolinium; optionally substituted quinolinium; optionally substituted pyrrolidinium; optionally substituted piperidinium; and mixtures thereof. In some preferred, non-limiting variations, the ionic liquid cation is optionally substituted imidazolium or optionally substituted pyridinium. In some non-limiting variations, the ionic liquid includes an ionic liquid anion selected from halide, lactate, acetate, perchlorate, tetrafluoroborate, hexafluorophosphate, hexafluoroantimonate, nitrite, nitrate, sulfate, phosphate, hydrogenphosphate, triflate, carbonate, C₂-C₆ carboxylate, and mixtures thereof. In some preferred, non-limiting variations, the ionic liquid anion is selected from one or more of halide, lactate, and acetate. In other preferred, non-limiting variations, the ionic liquid anion is acetate.

In some non-limiting variations, the composition includes an ionic liquid that is a 1,3-dialkylated imidazolium salt:

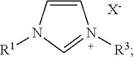

wherein each R1 and R3 are independently selected from optionally substituted C1-C6 alkyl and unsubstituted C1-C6 alkyl. In some preferred, non-limiting variations, each R1 and R3 are independently selected from methyl, ethyl, propyl, isopropyl, butyl, isobutyl, and tert-butyl.

In some non-limiting variations, the composition includes the ionic liquid 1-ethyl-3-methylimidazolium acetate or 1-butyl-3-methylimidazolium acetate and the salt K₃PO₄ or K₂HPO₄. In some preferred, non-limiting variations, the ionic liquid is 1-ethyl-3-methylimidazolium acetate and the salt is K₃PO₄.

In some non-limiting variations, the composition includes an aqueous phase and an ionic liquid phase. In some non-limiting variations, the aqueous phase includes 0-2 wt % of the ionic liquid. In some preferred, non-limiting variations, the aqueous phase includes 0-1 wt % of the ionic liquid. In other preferred, non-limiting variations, the aqueous phase includes 0-0.5 wt % of the ionic liquid. In some non-limiting variations, the aqueous phase includes 20-60 wt % of the salt. In some non-limiting variations, the aqueous phase includes 30-50 wt % of the salt. In some non-limiting variations, the aqueous phase includes 35-45 wt % of the salt.

The present invention also provides methods of pretreating biomass. These methods include the steps of (a) combining the biomass with an ionic liquid to form a first composition; (b) heating the first composition to form a pretreated biomass composition; (c) contacting a salt including a kosmotropic anion in an aqueous solution with the pretreated biomass composition to form an aqueous phase, an ionic liquid phase, and precipitated solids, wherein the aqueous phase includes 0-2 wt % of the ionic liquid; and (d) separating the aqueous phase, the ionic liquid phase, and the precipitated solids. In some non-limiting variations, the method further includes: (e) recycling the ionic liquid phase in a subsequent pretreatment.

In some non-limiting variations, the aqueous phase includes 0-1 wt % of the ionic liquid. In some preferred, non-limiting variations, the aqueous phase includes 0-0.5 wt % of the ionic liquid.

In some non-limiting variations, the kosmotropic anion used in the methods described herein is selected from phosphate, hydrogenphosphate, sulfate, ethylsulfate, borate, bromide, chloride, acetate, formate, citrate, and mixtures thereof. In some non-limiting variations, the salt further includes a cation selected from one or more of a Group IA metal, a Group IIA metal, a transition metal, and ammonium. In some preferred, non-limiting variations, the cation is selected from one or more of lithium, sodium, potassium, magnesium, calcium, and ammonium. In other preferred, non-limiting variations, the salt is potassium phosphate or potassium hydrogenphosphate.

In some non-limiting variations, the ionic liquid used in the methods described herein includes an ionic liquid cation selected from optionally substituted imidazolium; optionally substituted pyridinium; optionally substituted pyridazinium; optionally substituted pyrimidinium; optionally substituted pyrazinium; optionally substituted pyrazolium; optionally substituted thiazolium; optionally substituted 1,2,3-triazolium; optionally substituted 1,2,4-triazolium; optionally substituted oxazolium; optionally substituted isoquinolinium; optionally substituted quinolinium; optionally substituted pyrrolidinium; optionally substituted piperidinium; and mixtures thereof. In some preferred, non-limiting variations, the ionic liquid cation is optionally substituted imidazolium or optionally substituted pyridinium. In some non-limiting variations, the ionic liquid used in the methods described herein includes an ionic liquid anion selected from halide, lactate, acetate, perchlorate, tetrafluoroborate, hexafluorophosphate, hexafluoroantimonate, nitrite, nitrate, sulfate, phosphate, hydrogenphosphate, triflate, carbonate, C₂-C₆ carboxylate, and mixtures thereof. In some preferred, non-limiting variations, the ionic liquid anion is selected from one or more of halide, lactate, and acetate. In other preferred, non-limiting variations, the ionic liquid anion is acetate.

In some non-limiting variations of the methods described herein, the ionic liquid is a 1,3-dialkylated imidazolium salt:

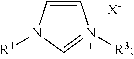

wherein each R1 and R3 are independently selected from optionally substituted C1-C6 alkyl and unsubstituted C1-C6 alkyl. In some preferred, non-limiting variations of the methods described herein, each R1 and R3 are independently selected from methyl, ethyl, propyl, isopropyl, butyl, isobutyl, and tert-butyl.

In some non-limiting variations of the methods described herein, the ionic liquid is 1-ethyl-3-methylimidazolium acetate or 1-butyl-3-methylimidazolium acetate and the salt is K₃PO₄ or K₂HPO₄. In some preferred, non-limiting variations, the ionic liquid is 1-ethyl-3-methylimidazolium acetate and the salt is K₃PO₄.

In some non-limiting variations, the heating is carried out at a temperature of 100-180° C. In other non-limiting variations, the heating is carried out at a temperature of 120-160° C. In some preferred, non-limiting variations, the heating is carried out at a temperature of 130-150° C.

In some non-limiting variations, the methods of the present invention further include providing conditions for enzymatic hydrolysis of the precipitated solids. In some variations, the enzymatic hydrolysis is carried out with cellulase enzymes.

In some non-limiting variations, the methods of the present invention further include cooling the pretreated biomass composition prior to the contacting step.

In some non-limiting variations of the methods described herein, 85-100% of the ionic liquid is recovered after separation from the precipitated solids and the aqueous phase. In some preferred, non-limiting variations, 90-100% of the ionic liquid is recovered after separation from the precipitated solids and the aqueous phase. In other preferred, non-limiting variations, 95-100% of the ionic liquid is recovered after separation from the precipitated solids and the aqueous phase.

In some non-limiting variations of the methods described herein, the biomass includes lignin and cellulose, and the precipitated solids include cellulosic material where at least 50% of the lignin originally present has been removed.

In some non-limiting variations of the methods described herein, the aqueous phase includes 20-60 wt % of the salt. In other non-limiting variations of the methods described herein, the aqueous phase includes 30-50 wt % of the salt. In other non-limiting variations of the methods described herein, the aqueous phase includes 35-45 wt % of the salt.

### DESCRIPTION OF DRAWING FIGURES

FIG. 1. Mutual coexistence curves for aqueous (a) [Bmim][Ac]/K₃PO₄; (b) [Emim][Ac]/K₃PO₄; (c) [Bmim][Ac]/K₂HPO₄; and (d) [Emim][Ac]/K₂HPO₄ systems. Scales are in weight fractions. System compositions above the coexistence curves are monophasic; compositions below the curve are biphasic. Tie lines (A) relate upper and lower phase compositions

FIG. 2. Exemplary schematic diagram of an ionic liquid pretreatment and recycle process.

FIG. 3. Enzymatic hydrolysis of Avicel under three pretreatment conditions. Avicel was pretreated with [Emim][Ac] at 70° C. for 18 hrs, and precipitated with either 40 wt % K₃PO₄ (◯) or water (). The untreated Avicel (Δ) hydrolysis profile is shown for comparison.

FIG. 4. Enzymatic hydrolysis of corn stover, pretreated with [Emim][Ac] at 70° C. for 44 hrs and precipitated with 40 wt % K₃PO₄. The hydrolysis of this biomass (◯) is compared with the hydrolysis of corn stover pretreated using the AFEX process ().

FIG. 5. Enzymatic hydrolysis of Miscanthus, pretreated with [Emim][Ac] at ° C. for 44 hrs and precipitated with water (Δ), 40 wt % K₃PO₄ (), or 40 wt % K₂HPO₄ (D). The hydrolysis of these pretreated substrates is compared to the hydrolysis of untreated Miscanthus (□).

FIG. 6. Enzymatic hydrolysis of Miscanthus using recycled [Emim][Ac]. The Miscanthus was pretreated first with fresh [Emim][Ac] at 140° C. for 1 hr, and then precipitated with 40 wt % K₃PO₄ (◯). The ionic liquid rich phase was then recycled to pretreat Miscanthus, which was then also precipitated with the recycled K₃PO₄ (, Δ).

### DETAILED DESCRIPTION

The following description sets forth exemplary methods, parameters and the like. It should be recognized, however, that such description is not intended as a limitation on the scope of the present proposed invention but is instead provided as a description of exemplary embodiments.

### 1. DEFINITIONS

As used herein, the term “biomass” refers to a material that is derived from a living or dead plant source. “Biomass” includes any plant material that contains lignin, cellulosic, hemicellulosic, and/or lignocellulosic components. The methods of the present invention may be performed with raw plant material; mixtures of cellulose and hemicellulose; mixtures of cellulose, hemicellulose, and lignin; or purified forms of cellulose or hemicellulose.

As used herein, the term “kosmotropic” refers to solutes which contribute to the stability and structure of water molecule interactions. The compositions and methods of the present invention include one or more kosmotropic anions. The kosmotropic anion may be phosphate, hydrogenphosphate, sulfate, ethylsulfate, borate, bromide, chloride, acetate, formate, citrate, and mixtures thereof. When the kosmotropic anion is in the salt form, the cation may be a Group IA metal ion such as lithium, sodium, and potassium; a Group IIA metal ion such as magnesium or calcium; ammonium; or a transition metal cation such as iron.

As used herein, the term “ionic liquid,” abbreviated throughout as “IL” is a salt that exists in a liquid phase over a broad temperature range. Generally, ILs exhibit low viscosity, very low vapor pressure, and high solubility for a variety of organic, inorganic, and polymeric materials.

As used herein, the terms “cellulase,” “cellulases,” and “cellulase enzymes” refer to enzymes that are capable of hydrolyzing cellulose. The enzymes are typically produced by fungi, plants, bacteria, protozoa, and other organisms. The hydrolysis of cellulose by cellulases produces smaller oligomers of cellulose, cellobiose, and/or glucose.

As used herein, “optionally substituted” indicates that the particular group or groups being described may have no non-hydrogen substituents, or the group or groups may have one or more non-hydrogen substituents. If not otherwise specified, the total number of such substituents that may be present is equal to the number of H atoms present on the unsubstituted form of the group being described.

As used herein, the singular forms “a,” “an,” and “the” include plural forms unless the context clearly dictates otherwise. For example, reference to “an ionic liquid” includes mixtures of two or more such ionic liquids, reference to “a kosmotropic anion” includes mixtures of two or more such kosmotropic anions, and the like.

### 2. DESCRIPTION OF THE INVENTION

The present invention provides compositions and methods for pretreating and enzymatically hydrolyzing biomass in an ionic liquid. The present invention also relates to methods of pretreating cellulosic biomass in an ionic liquid, adding a kosmotropic anion or water soluble polymer to facilitate separation of precipitated solids, an aqueous phase, and an ionic liquid phase. The ionic liquid phase may be recycled in a subsequent pretreatment step. The precipitated solids are cellulose-rich, may be separated from the ionic liquid and aqueous phases, and may be enzymatically hydrolyzed by cellulase enzymes.

The biomass used in the present invention is typically heterogeneous, and may include cellulosic material, lignocellulosic material, hemicellulosic material, lignin, oligosaccharides, monosaccahrides, biopolymers, proteins, lipids, and starch. The biomass may be derived from a single source or from multiple sources. Non-limiting sources of biomass include agricultural crops, agricultural residues, livestock solid waste, industrial solid waste, human sewage, yard waste, wood and forestry waste, corn stover, grasses, wheat, hay, wheat straw, sugar cane bagasse, sorghum, soy, vegetables, fruits, flowers, and sludge from paper manufacture.

In some non-limiting variations, the present invention provides compositions including: (a) biomass; (b) an ionic liquid; (c) water; and (d) a salt including a kosmotropic anion selected from phosphate, hydrogenphosphate, sulfate, ethylsulfate, borate, bromide, chloride, acetate, formate, citrate, and mixtures thereof. In other non-limiting variations, the salt further includes a cation selected from one or more of a Group IA metal, a Group IIA metal, a transition metal, and ammonium. In some preferred variations, the cation is selected from one or more of the group of lithium, sodium, potassium, magnesium, calcium, and ammonium. In some preferred variations, the salt is potassium phosphate or potassium hydrogenphosphate.

In some non-limiting variations, the ionic liquid includes an ionic liquid cation selected from one or more of optionally substituted imidazolium; optionally substituted pyridinium; optionally substituted pyridazinium; optionally substituted pyrimidinium; optionally substituted pyrazinium; optionally substituted pyrazolium; optionally substituted thiazolium; optionally substituted 1,2,3-triazolium; optionally substituted 1,2,4-triazolium; optionally substituted oxazolium; optionally substituted isoquinolinium; optionally substituted quinolinium; optionally substituted pyrrolidinium; optionally substituted piperidinium; and mixtures thereof. In some preferred, non-limiting variations, the ionic liquid cation is optionally substituted imidazolium or optionally substituted pyridinium. In some non-limiting variations, the ionic liquid includes an ionic liquid anion selected from one or more of halide, lactate, acetate, perchlorate, tetrafluoroborate, hexafluorophosphate, hexafluoroantimonate, nitrite, nitrate, sulfate, phosphate, hydrogenphosphate, triflate, carbonate, C₂-C₆ carboxylate, and mixtures thereof. In some preferred, non-limiting variations, the ionic liquid anion is selected from one or more of halide, lactate, and acetate. In other preferred, non-limiting variations, the ionic liquid anion is acetate.

Although some of the ionic liquid anions overlap with the kosmotropic anions disclosed herein, the ionic liquid anion is not the same as the kosmotropic anion. In other words, the kosmotropic anion cannot be an anion from the ionic liquid. The kosmotropic anion present in the compositions described herein is typically contacted with the ionic liquid when in salt form.

In some non-limiting variations, the ionic liquid is a 1,3-dialkylated imidazolium salt:

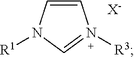

wherein each R1 and R3 are independently selected from optionally substituted C1-C6 alkyl and unsubstituted C1-C6 alkyl. In some preferred, non-limiting variations, each R1 and R3 are independently selected from methyl, ethyl, propyl, isopropyl, butyl, isobutyl, and tert-butyl.

In some non-limiting variations, the ionic liquid is 1-ethyl-3-methylimidazolium acetate or 1-butyl-3-methylimidazolium acetate and the salt is K₃PO₄ or K₂HPO₄. In some preferred, non-limiting variations, the ionic liquid is 1-ethyl-3-methylimidazolium acetate and the salt is K₃PO₄.

In some non-limiting variations, the composition includes an aqueous phase and an ionic liquid phase. In some non-limiting variations, the aqueous phase includes 0-2 wt % of the ionic liquid. In some preferred, non-limiting variations, the aqueous phase includes 0-1 wt % of the ionic liquid. In other preferred, non-limiting variations, the aqueous phase includes 0-0.5 wt % of the ionic liquid. In some non-limiting variations, the aqueous phase includes 20-60 wt % of the salt. In some non-limiting variations, the aqueous phase includes 30-50 wt % of the salt. In some non-limiting variations, the aqueous phase includes 35-45 wt % of the salt.

The present invention also provides methods of pretreating biomass. These methods include the steps of (a) combining the biomass with an ionic liquid to form a first composition; (b) heating the first composition to form a pretreated biomass composition; (c) contacting a salt including a kosmotropic anion in an aqueous solution with the pretreated biomass composition to form an aqueous phase, an ionic liquid phase, and precipitated solids, wherein the aqueous phase includes 0-2 wt % of the ionic liquid; (d) separating the aqueous phase, the ionic liquid phase, and the precipitated solids; and (e) recycling the ionic liquid phase in a subsequent pretreatment.

In some non-limiting variations, the aqueous phase includes 0-1 wt % of the ionic liquid. In some preferred, non-limiting variations, the aqueous phase includes 0-0.5 wt % of the ionic liquid.

In some non-limiting variations, the kosmotropic anion used in the methods described herein is selected from phosphate, hydrogenphosphate, sulfate, ethylsulfate, borate, bromide, chloride, acetate, formate, citrate, and mixtures thereof. In some non-limiting variations, the salt further includes a cation selected from one or more of a Group IA metal, a Group IIA metal, a transition metal, and ammonium. In some preferred, non-limiting variations, the cation is selected from one or more of lithium, sodium, potassium, magnesium, calcium, and ammonium. In other preferred, non-limiting variations, the salt is potassium phosphate or potassium hydrogenphosphate.

In some non-limiting variations, the ionic liquid used in the methods described herein includes an ionic liquid cation selected from optionally substituted imidazolium; optionally substituted pyridinium; optionally substituted pyridazinium; optionally substituted pyrimidinium; optionally substituted pyrazinium; optionally substituted pyrazolium; optionally substituted thiazolium; optionally substituted 1,2,3-triazolium; optionally substituted 1,2,4-triazolium; optionally substituted oxazolium; optionally substituted isoquinolinium; optionally substituted quinolinium; optionally substituted pyrrolidinium; optionally substituted piperidinium; and mixtures thereof. In some preferred, non-limiting variations, the ionic liquid cation is optionally substituted imidazolium or optionally substituted pyridinium. In some non-limiting variations, the ionic liquid used in the methods described herein includes an ionic liquid anion selected from halide, lactate, acetate, perchlorate, tetrafluoroborate, hexafluorophosphate, hexafluoroantimonate, nitrite, nitrate, sulfate, phosphate, hydrogenphosphate, triflate, carbonate, C₂-C₆ carboxylate, and mixtures thereof. In some preferred, non-limiting variations, the ionic liquid anion is selected from one or more of halide, lactate, and acetate. In other preferred, non-limiting variations, the ionic liquid anion is acetate.

In some non-limiting variations of the methods described herein, the ionic liquid is a 1,3-dialkylated imidazolium salt:

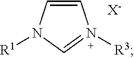

wherein each R1 and R3 are independently selected from optionally substituted C1-C6 alkyl and unsubstituted C1-C6 alkyl. In some preferred, non-limiting variations of the methods described herein, each R1 and R3 are independently selected from methyl, ethyl, propyl, isopropyl, butyl, isobutyl, and tert-butyl.

In some non-limiting variations of the methods described herein, the ionic liquid is 1-ethyl-3-methylimidazolium acetate or 1-butyl-3-methylimidazolium acetate and the salt is K₃PO₄ or K₂HPO₄. In some preferred, non-limiting variations, the ionic liquid is 1-ethyl-3-methylimidazolium acetate and the salt is K₃PO₄.

In some non-limiting variations, the heating is carried out at a temperature of 100-180° C. In other non-limiting variations, the heating is carried out at a temperature of 120-160° C. In some preferred, non-limiting variations, the heating is carried out at a temperature of 130-150° C.

In some non-limiting variations, the methods of the present invention further include providing conditions for enzymatic hydrolysis of the precipitated solids. In some variations, the enzymatic hydrolysis is carried out with cellulase enzymes.

In some non-limiting variations, the methods of the present invention further include cooling the pretreated biomass composition prior to the contacting step.

In some non-limiting variations of the methods described herein, 85-100% of the ionic liquid is recovered after separation from the precipitated solids and the aqueous phase. In some preferred, non-limiting variations, 90-100% of the ionic liquid is recovered after separation from the precipitated solids and the aqueous phase. In other preferred, non-limiting variations, 95-100% of the ionic liquid is recovered after separation from the precipitated solids and the aqueous phase.

In some non-limiting variations of the methods described herein, the biomass includes lignin and cellulose, and the precipitated solids include cellulosic material where at least 50% of the lignin originally present has been removed.

In some non-limiting variations of the methods described herein, the aqueous phase includes 20-60 wt % of the salt. In other non-limiting variations of the methods described herein, the aqueous phase includes 30-50 wt % of the salt. In other non-limiting variations of the methods described herein, the aqueous phase includes 35-45 wt % of the salt.

### Examples

The following examples are offered to illustrate but not to limit the invention.

Materials

Ionic liquids: all ionic liquids were purchased from IOLITEC. [Emim][Ac] was >95% pure, and used without further purification.

Salts: K₃PO₄ and K₂HPO₄ salts were purchased from Sigma Aldrich.

Cellulase enzymes: cellulases from Trichoderma reesei (Celluclast 1.5 L Product # C2730-50 ml) and β-glucosidase (Novo188 Product # C6105-50 ml) were purchased from Sigma Aldrich. The activity of the Celluclast 1.5 L was reported to be 800 EGU/g, and of Novo188 to be 258 CBU/g. The IUPAC Filter Paper Assay (Ref. 28) was performed on the Celluclast 1.5 L and found to be 130 FPU/mL of solution.

Substrates: Miscanthus from the University of Illinois, Urbana-Champaign was ground and placed through a 4 mm particle size sieve plate. Avicel (50 um size) was purchased from Sigma Aldrich. Corn stover (both AFEX pretreated and unpretreated) was provided by Dr. Bruce Dale from Michigan State University, and the composition of the corn stover was determined by the GLBRC at MSU. Table 1 shows the composition of the substrates.

TABLE 1
Composition of biomass samples. Samples were not dried.
ND indicates composition not determined.

| | wt % | | | | | | |
|---|---|---|---|---|---|---|---|
| Material | Moisture | Cellulose | Hemicellulose | Lignin | Extractables | Ash | Protein |
| Miscanthus | 8.0 | 36.8 | 22.1 | 23.9 | 6.1 | 3.2 | 0.9 |
| Avicel | 4.0 | 96 | ND | ND | ND | ND | ND |
| Corn Stover | 5.9 | 34.8 | 27.5 | 20.6 | 8 | 3.2 | ND |

Analytical Methods

Monosaccharide analysis: sugar concentrations were determined by Dionex HPLC. A CarboPac PA20, using a (150 mm×3 mm) column equipped with a de-ashing guard column (30 mm×3 mm) and amperometric detector. 18 mM NaOH solution was used as the mobile phase at 0.4 ml/min at 30° C. The injection volume was 20 μL with a run time of 25 min. Mixed sugar standards were used for quantification of glucose, xylose, galactose, arabinose and mannose in the samples. Glucose concentrations were determined during enzymatic hydrolysis of biomass by a YSI 2700 SELECT Biochemistry Analyzer configured with a membrane for glucose detection.

Lignin analysis: to determine the content of lignin in the liquid phases, Klason lignin was used as a standard. Klason lignin was obtained by first treating Miscanthus with 72 wt % sulfuric acid at room temperature for 1.0 h. The sample was then diluted with water to a sulfuric acid concentration of 4.0 wt % and autoclaved for 1.0 h under 121° C. After filtration through a glass filter, washing with hot water, and heating in an oven at 105° C. overnight, the acid-insoluble residue was collected as Klason lignin. It contained 8.0 wt % ash and protein.

Klason lignin (1.0 mg) was dissolved in 1.0 g [EMIM][Ac] at 70° C. The sample was cooled and diluted with water 40, 50, 100, 200, or 300 fold to provide concentrations for a standard curve. A blank sample was prepared from the same solution without the Klason lignin. The UV absorbances of the five solutions at 280 nm were recorded against the blank solution to provide a standard curve. The lignin content of samples was determined from their absorption at 280 nm after dilution. Any absorption due to 5-HMF and furfural was neglected in determining the lignin concentration.

Cellulose and hemicellulose analysis: to determine the cellulose and hemicellulose content in the IL and aqueous phases, 0.1 ml of 12.0M H₂SO₄ and 1.0 ml distilled water were mixed with 0.1 ml sample, then autoclaved at 121° C. for 1.0 hour. This ensured complete hydrolysis of cellulose and hemicellulose to monosaccharides. Samples were filtered through 0.45 μm PTFE-membranes to remove high molecular mass components (such as lignin) before analysis. The monosaccharides in the filtrate were determined by Dionex HPLC as described above. To determine the cellulose and hemicellulose contents of the solid precipitate phase, a known amount of solid was incubated in 12.0 M H₂SO₄ solution for 1.0 hour at room temperature. Then the samples were diluted to a 1.0 M H₂SO₄ final concentration with distilled water and autoclaved at 121° C. for 1.0 hour (REF NREL). Monosaccharides concentrations were then determined by Dionex HPLC. Cellulose and hemicelluloses contents were calculated from the concentrations of the resulting hexose and pentose sugars.

Ionic liquid-aqueous systems phase diagrams: mutual coexistence curves were determined by the cloud point method. The corresponding tie lines of each system were obtained to characterize the composition of the two phases. A series of five stock solutions for four IL/salt systems were prepared with IL/salt/H₂O compositions of (1) 26/18/56, (2) 30/20/50, (3) 34/22/44, (4) 40/25/35 and (5) 46/27/27 wt %, respectively. The concentrations of anions [PO₄]³⁻ and [HPO₄]²⁻, when present in IL-rich phases, were determined by mixing with malachite green reagent (basic green 4 or Victoria green B). The rapid color formation from the reaction was measured by UV absorption at 600 nm and concentrations determined from a standard curve. The concentrations of [Ac]⁻, [PO₄]³⁻ and [HPO₄]²⁻, when present in aqueous phases, were measured by high-performance liquid chromatography (HPLC) with isocratic elution. The mobile phase, 0.01 N sulfuric acid solution, was set at a rate of 0.6 ml/min. A Bio-Rad Aminex HPX-87H on exclusion column (300 mm×7.8 mm, catalog 125-0140) and a refractive index detector were used. Column temperature was constant at 50° C. The retention time of [Ac]⁻ was 15.0 min; for [PO₄]³⁻ and [HPO₄]²⁻ it was 9.0 min. Calibration curves of [EMIM][Ac], [BMIM][Ac], K₂HPO₄ and K₃PO₄ were made separately. The concentrations of ILs were obtained based on the assumption that the ratio of cation and anion of ionic liquids in each phase is 1:1. The concentrations of K₂HPO₄ and K₃PO₄ from these two measurements were consistent. Karl-Fisher titration was used to measure the water content in all samples. The material balances closed to within ±5.0%.

Ionic Liquid Recovery Using Aqueous Biphasic Systems

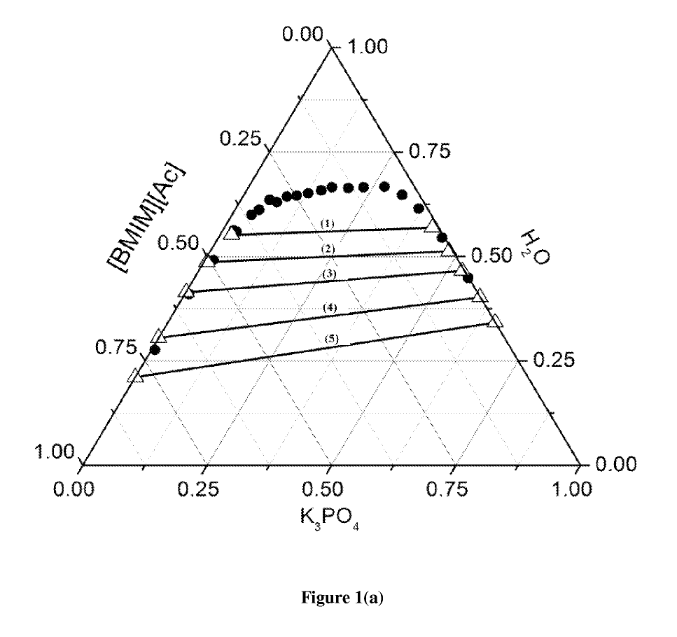

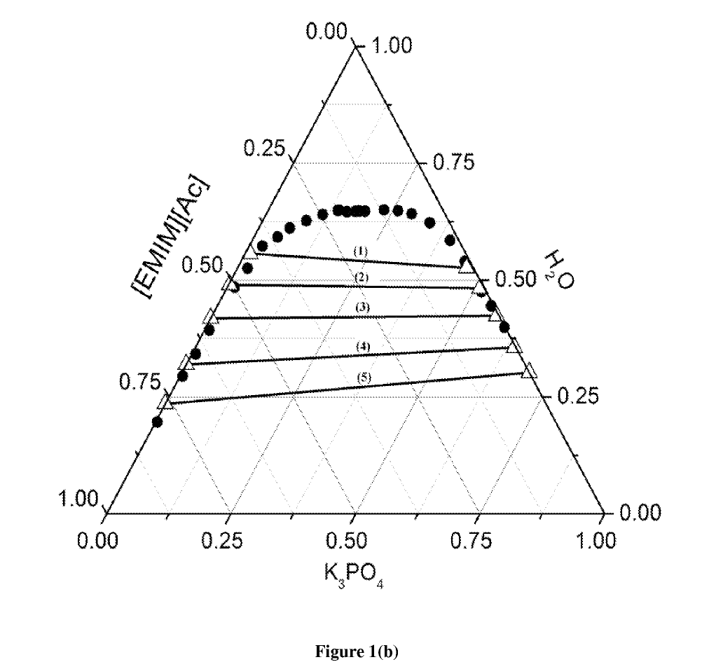

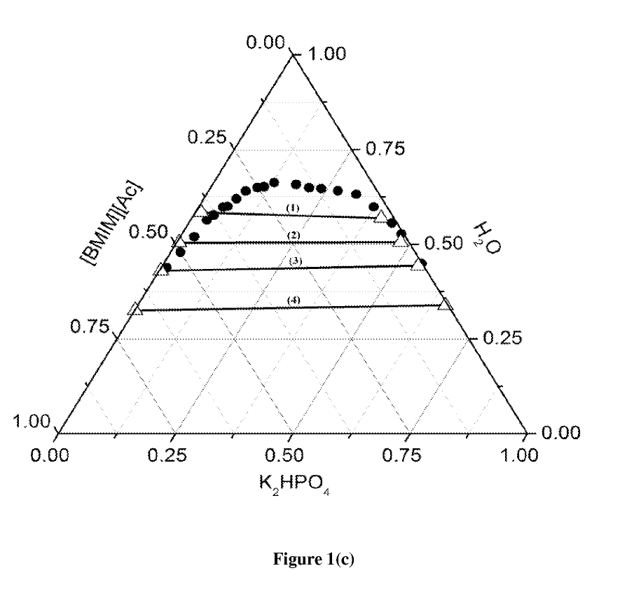

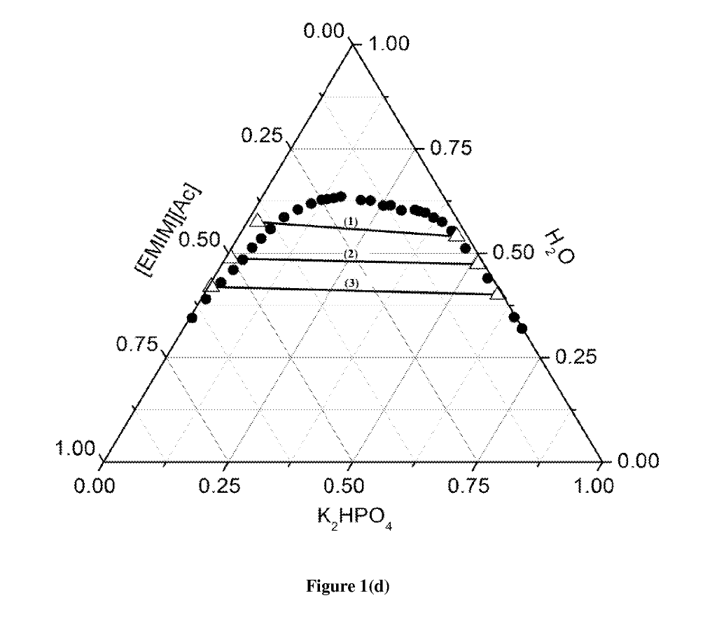

Both [Emim][Ac] or [Bmim][Ac] can be used to form aqueous biphasic systems when contacted with a concentrated solution of a water-structuring salt, such as K₃PO₄ or K₂HPO₄. Both salts induce the formation of an upper IL-rich phase and a lower salt-rich phase. Toward better understanding of this potential separation process, ternary liquid-liquid equilibria were determined at 22° C. FIG. 1 shows the ternary phase diagrams for the ionic liquids ([Bmim][Ac] and [Emim][Ac]) with K₃PO₄ and K₂HPO₄.

Comparing panels (a) and (c) in FIG. 1, the more kosmotropic K₃PO₄ provides a more effective phase separation than K₂HPO₄. The extent of separation is governed by the Gibbs free energy of hydration of the salt. Due to the lower solubility of K₂HPO₄ and its less kosmotropic nature, K₂HPO₄ forms a solid phase at concentrations corresponding to the (4) and (5) tie lines in FIG. 1 (c) and (d). Since the longer alkyl chain in [Bmim][Ac] renders it more hydrophobic than [Emim][Ac], the [Bmim][Ac]/salt systems exhibit a greater phase separation than [Emim][Ac]/salt systems, as evidenced in panels (a) and (b) in FIG. 1.

As the concentration of K₃PO₄ or K₂HPO₄ in the system increases, the ionic liquids become more concentrated in the upper phase, with less phosphate is present in this phase. A recovery of over 95.0% of the ionic liquid in K₃PO₄-containing systems can be obtained. The pH of the aqueous phase in IL/K₃PO₄ systems was pH 12 to 13, while that the pH for IL/K₂HPO₄ systems was between pH 9 and 10.

Pretreatment of Biomass with Ionic Liquids

Aqueous biphasic systems provide a method to separate lignin from cellulose and hemicellulose. Miscanthus was dissolved in [Emim][Ac] or [Bmim][Ac] and a strongly basic aqueous solution of phosphate was added. The resulting three-phase system has a salt-rich aqueous phase, a solid-phase rich in cellulose, and an IL-rich phase containing most of the lignin. For example, 1.0 g Miscanthus (or 0.5 g Avicel) was added to 25 mL [Emim][Ac] and incubated at 140° C. for 1.0 h with stirring. The samples were then cooled to 70° C., and 25.0 ml of 40.0 wt % K₃PO₄ solution at 70° C. was added to precipitate the cellulosic components. The samples were cooled to room temperature and centrifuged to provide a well-defined three-phase system. The IL and salt-rich phases were removed, and the remaining solids were washed with citrate buffer (50 mM pH 4.8), to remove any residual IL in preparation for enzymatic hydrolysis. Similar procedures were followed for K₂HPO₄ solutions.

Recovery of Ionic Liquid and Material Balances

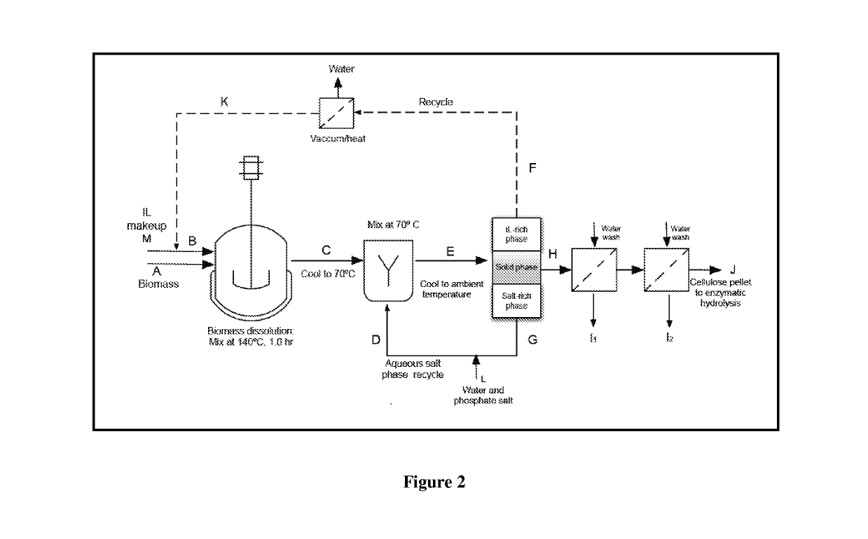

A detailed mass balance was performed for each step in the IL pretreatment and recycle process (FIG. 2). The wt % of the three main components of Miscanthus was measured in each phase and in the wash steps. The contents of each stream in FIG. 2 are provided in Table 2 (a), b), (c) for the first use, and two subsequent recycles of IL employed in the process. The aqueous phosphate solution in the lower phase contained a high concentration of salt and only contained trace amounts of IL and sugars. It was reused directly. The IL-rich phase was recycled after removal of the water by evaporation. Some IL and K₃PO₄ were lost in the washing steps. While this loss could be minimized by optimizing the washing steps, it was not attempted in the present work.

Table 2. Compositions of streams indicated in FIG. 2. Table 2(a) indicates compositions obtained from the first use of [Emim][Ac], hence stream D contains only phosphate. Subsequently, the salt-rich phase is recycled, and stream D contains other components. Weights of each component in each stream are given in gm; % indicates the percentage of the initial amount of each component present in each stream; ND indicates composition not determined.

TABLE 2(a)
Compositions of streams in first cycle. Streams A-M are shown in FIG. 2.

| | Cellulose | | Hemicellulose | | Lignin | | [Emim][Ac] | | K₃PO₄ | |
|---|---|---|---|---|---|---|---|---|---|---|
| Stream | gm | % | gm | % | gm | % | gm | % | gm | % |
| A | 0.37 | 100 | 0.22 | 100 | 0.23 | 100 | — | — | — | — |
| B | — | — | — | — | — | — | 25.0 | 100 | — | — |
| C | 0.37 | 100 | 0.22 | 100 | 0.23 | 100 | 25.0 | 100 | — | — |
| D | — | — | — | — | — | — | — | — | 14.9 | 100 |
| E | 0.37 | 100 | 0.22 | 100 | 0.23 | 100 | 25.0 | 100 | 14.9 | 100 |
| F | 0.005 | 1.4 | 0.018 | 8.2 | 0.078 | 34 | 18.0 | 72 | 0.02 | 0.13 |
| G | 0.004 | 1.1 | 0.0008 | 0.4 | 0.0003 | 0.13 | 0.04 | 0.16 | 9.5 | 64 |
| H | 0.36 | 98 | 0.20 | 91 | 0.15 | 66 | ND | ND | ND | ND |
| I₁ | 0.01 | 2.7 | 0.061 | 28 | 0.04 | 17 | 5.3 | 21 | 2.34 | 16 |
| I₂ | 0.005 | 1.4 | 0.023 | 11 | 0.01 | 4.3 | 1.8 | 7.2 | 0.91 | 6.1 |
| J | 0.355 | 96 | 0.12 | 55 | 0.072 | 31 | ND | ND | ND | ND |
| K | 0.005 | 1.4 | 0.018 | 8.2 | 0.078 | 34 | 18.0 | 72 | 0.02 | 0.13 |
| L | — | — | — | — | — | — | — | — | 5.4 | 36 |
| M | — | — | — | — | — | — | 7.0 | 28 | — | — |

TABLE 2(b)
Composition of streams in the second cycle of the ionic liquid. Streams
A-M are shown in FIG. 2.

| | Cellulose | | Hemicellulose | | Lignin | | [Emim][Ac] | | K₃PO₄ | |
|---|---|---|---|---|---|---|---|---|---|---|
| Stream | gm | % | gm | % | gm | % | gm | % | gm | % |
| A | 0.37 | 97 | 0.22 | 92 | 0.23 | 74 | — | — | — | — |
| B | 0.005 | 1.3 | 0.018 | 7.5 | 0.078 | 25 | 25.0 | 100 | 0.02 | 0.13 |
| C | 0.375 | 99 | 0.24 | 100 | 0.31 | 100 | 25.0 | 100 | 0.02 | 0.13 |
| D | 0.004 | 1.1 | 0.0008 | 0.33 | 0.0003 | 0.1 | 0.04 | 0.16 | 14.9 | 100 |
| E | 0.38 | 100 | 0.24 | 100 | 0.31 | 100 | 25.04 | 100 | 14.92 | 100 |
| F | 0.004 | 1.1 | 0.019 | 7.9 | 0.12 | 39 | 16.0 | 64 | 0.04 | 0.27 |
| G | 0.002 | 0.53 | 0.0003 | 0.13 | 0.0004 | 0.13 | 0.08 | 0.32 | 10.0 | 67 |
| H | 0.37 | 98 | 0.22 | 92 | 0.19 | 61 | ND | ND | ND | ND |
| I₁ | 0.007 | 1.8 | 0.096 | 40 | 0.086 | 28 | 7.0 | 28 | 1.57 | 11 |
| I₂ | 0.006 | 1.6 | 0.017 | 7.1 | 0.011 | 3.5 | 2.2 | 8.8 | 0.34 | 2.3 |
| J | 0.347 | 91 | 0.116 | 48 | 0.12 | 39 | ND | ND | ND | ND |
| K | 0.004 | 1.1 | 0.019 | 7.9 | 0.12 | 39 | 16.0 | 64 | 0.04 | 0.27 |
| L | — | — | — | — | — | — | — | — | 4.9 | 33 |
| M | — | — | — | — | — | — | 9.0 | 36 | — | — |

TABLE 2(c)
Composition of streams in the third cycle of the ionic liquid. Streams A-M
are shown in FIG. 2.

| | Cellulose | | Hemicellulose | | Lignin | | [Emim][Ac] | | K₃PO₄ | |
|---|---|---|---|---|---|---|---|---|---|---|
| Stream | gm | % | gm | % | gm | % | gm | % | gm | % |
| A | 0.37 | 98 | 0.22 | 92 | 0.23 | 66 | — | — | — | — |
| B | 0.004 | 1.1 | 0.019 | 7.9 | 0.114 | 33 | 25.0 | 100 | 0.04 | 0.27 |
| C | 0.374 | 100 | 0.239 | 100 | 0.344 | 98 | 25.0 | 100 | 0.04 | 0.27 |
| D | 0.002 | 0.53 | 0.0003 | 0.13 | 0.0004 | 0.11 | 0.08 | 0.32 | 14.9 | 100 |
| E | 0.376 | 100 | 0.24 | 100 | 0.35 | 100 | 25.1 | 100 | 14.94 | 100 |
| F | 0.005 | 1.3 | 0.01 | 4.2 | 0.155 | 44 | 14.3 | 57 | 0.02 | 0.13 |
| G | 0.004 | 1.1 | 0.0008 | 0.33 | 0.0003 | 0.09 | 0.088 | 0.35 | 12.2 | 82 |
| H | 0.37 | 98 | 0.23 | 95 | 0.19 | 56 | ND | ND | ND | ND |
| I₁ | 0.011 | 2.9 | 0.08 | 33 | 0.097 | 28 | 5.73 | 23 | 1.5 | 10 |
| I₂ | 0.002 | 0.53 | 0.02 | 8.3 | 0.049 | 14 | 4.5 | 18 | 0.59 | 3.9 |
| J | 0.357 | 95 | 0.10 | 42 | 0.088 | 25 | ND | ND | ND | ND |
| K | 0.005 | 1.3 | 0.01 | 4.2 | 0.155 | 44 | 14.3 | 57 | 0.02 | 0.13 |
| L | — | — | — | — | — | — | — | — | 2.7 | 18 |
| M | — | — | — | — | — | — | 10.7 | 43 | — | — |

Enzymatic Hydrolysis of IL-Pretreated Cellulose and Miscanthus

The regenerated solids (Miscanthus or Avicel) were recovered from the phase separation and washed, then placed in a 125 mL volumetric flask with additional citrate buffer (50 mM pH 4.8) for a total mass of 50 g. A loading of 0.065 mL of Celluclast was added (for Avicel, 0.078 mL was used; for corn stover, 0.0625 mL), with β-glucosidase added at a 1:1 volume ratio. The enzymatic hydrolysis was conducted at 50° C. with shaking at 250 rpm in a Talboys Incubating Orbital Shaker. Samples (0.5 mL to 2 mL) were removed and diluted with water (lx-7×) as necessary and analyzed by the YSI for glucose concentration. Reactions were run in duplicate, with samples taken from each reactor and run twice on the YSI.

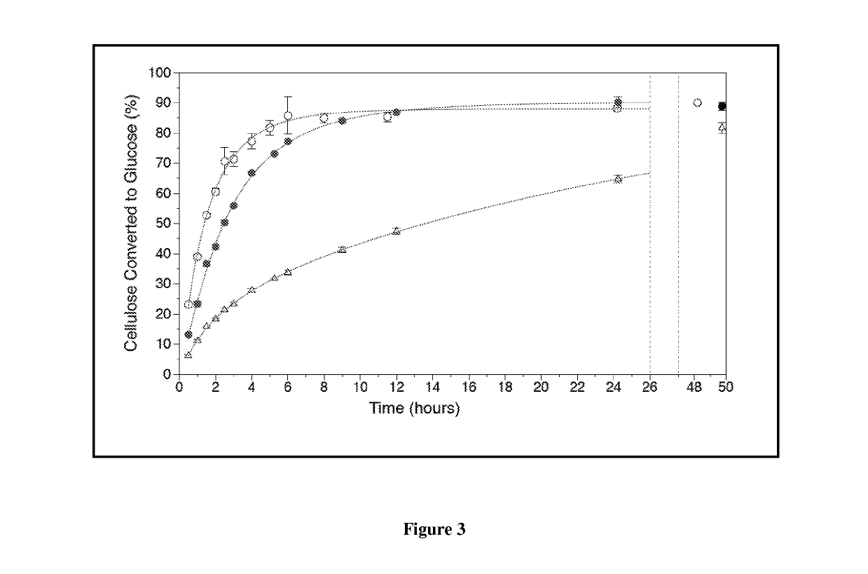

FIGS. 3-6 show the percentage conversion of cellulose to glucose following hydrolysis as a function of time. The percent conversion is based on the mass of biomass used in the pretreatment, and thus represents an overall process conversion of cellulose to glucose (Table 3). The percent conversion is calculated using the following formula:

$$Percent conversion = \frac{Glucose concentration \times volume of reaction}{mass of biomass \times fraction cellulose in biomass} \times \frac{162 ( MW of cellulose unit )}{180 ( MW of glucose unit )} \times {10}^{2}$$

FIG. 3 shows the hydrolysis of Avicel over time, pretreated with [Emim][Ac] for 18 hours at 70° C. and precipitated with either water or 40 wt % K₃PO₄ solution, compared to Avicel with no pretreatment. Avicel was studied to probe the effect of IL pretreatment on the cellulosic portion of biomass. All reactions attained a conversion above 80% in 50 hours, however the Avicel pretreated with [Emim][Ac] reached this in a shorter time (9 hours for water precipitated, 5 hours for salt precipitated).

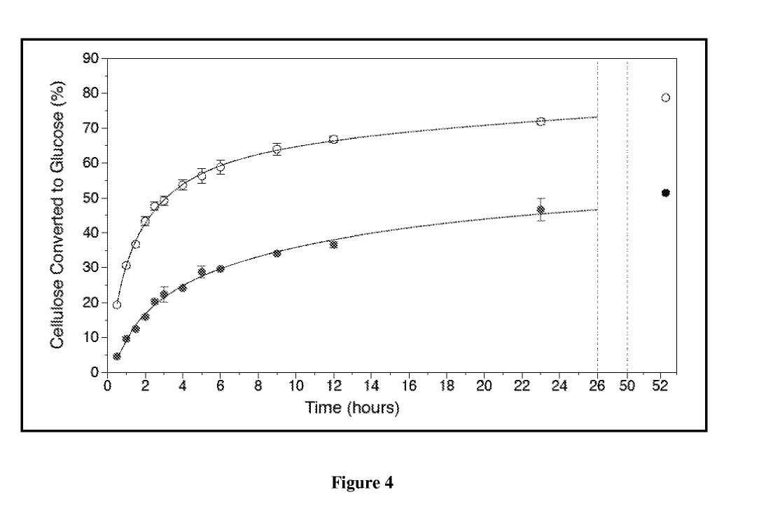

FIG. 4 shows the conversion of corn stover to glucose as a function of time. The corn stover was either pretreated with [Emim][Ac] for 44 hours at 70° C. and precipitated with 40 wt % K₃PO₄ solution, or pretreated with the AFEX process. After 52 hours, the [Emim][Ac] pretreated corn stover reached 80% conversion, whereas the AFEX pretreated substrate only achieved 50% conversion.

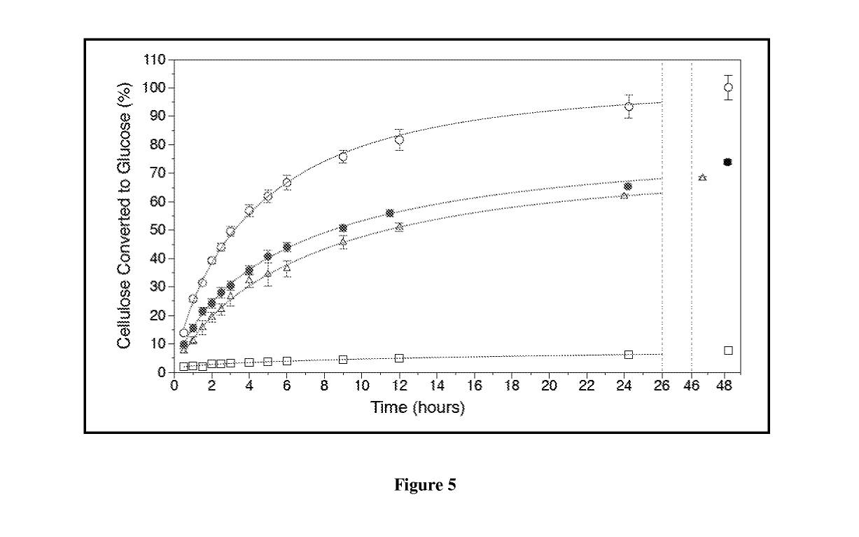

FIG. 5 shows the hydrolysis of Miscanthus pretreated with [Emim][Ac] for 44 hours at 70° C. A long pretreatment time and low temperature were chosen to insure full dissolution without side reactions that could alter the biomass. The Miscanthus was precipitated with three different solutions, 40 wt % K₃PO₄ solution, water and 40 wt % K₂HPO₄ solution. The hydrolyses of these pretreated substrates were compared to the hydrolysis of untreated Miscanthus. The Miscanthus pretreated with [Emim][Ac] and precipitated with K₃PO₄ reached full conversion in 48 hours, whereas the substrates precipitated with water and K₂HPO₄ only reached 63% and 68% conversion respectively. All performed with higher conversions than untreated Miscanthus, which only reached 5% conversion.

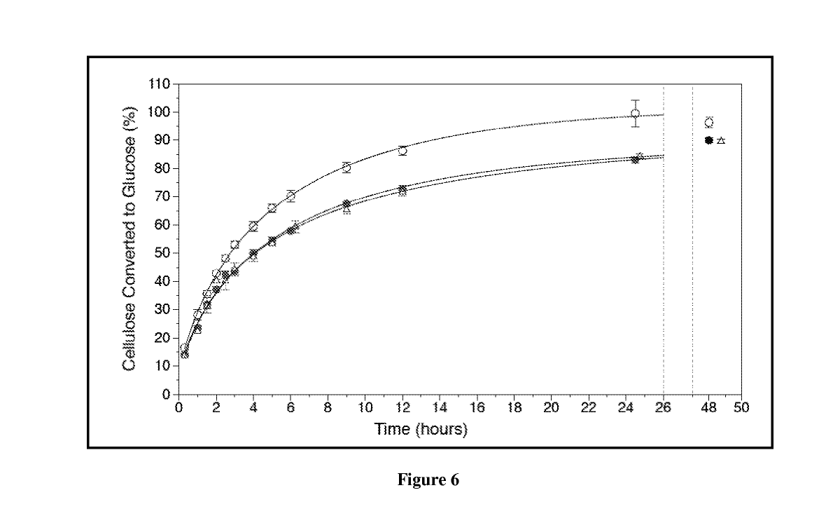

FIG. 6 shows the hydrolysis of Miscanthus pretreated with fresh and recycled [Emim][Ac] for 1 hour at 140° C. and precipitated with 40 wt % K₃PO₄ solution. This process had a short time and high temperature, and reached complete conversion of the cellulose in less than 25 hours. The reactions with recycled [Emim][Ac] reached full conversion in 48 hours.

TABLE 3
Percentage conversion of cellulose to glucose after 48
hours. The percent conversion is based on the mass of
biomass used in the pretreatment, and thus represents
an overall process conversion of cellulose to glucose.

| | Pretreatment Conditions | | | | |
|---|---|---|---|---|---|
| | | Time | Tempera- | Anti- | Percent |
| Substrate | Solvent | (hrs) | ture (° C.) | solvent | Conversion |
| Avicel | None | — | — | — | 82 |
| | [Emim][Ac] | 18 | 70 | water | 89 |
| | [Emim][Ac] | 18 | 70 | 40 wt % | 90 |
| | | | | K₃PO₄ | |
| Corn Stover | AFEX | — | — | — | 51 |
| | [Emim][Ac] | 44 | 70 | 40 wt % | 79 |
| | | | | K₃PO₄ | |
| Miscanthus | None | — | — | — | 7.7 |
| | [Emim][Ac] | 44 | 70 | water | 68 |
| | [Emim][Ac] | 44 | 70 | 40 wt % | 74 |
| | | | | K₂HPO₄ | |
| | [Emim][Ac] | 44 | 70 | 40 wt % | 100 |
| | | | | K₃PO₄ | |
| | [Emim][Ac] | 1 | 140 | 40 wt % | 96 |
| | | | | K₃PO₄ | |
| | 1st Recycle | 1 | 140 | 40 wt % | 90 |
| | [Emim][Ac] | | | K₃PO₄ | |
| | 2nd Recycle | 1 | 140 | 40 wt % | 90 |
| | [Emim][Ac] | | | K₃PO₄ | |

A three-phase system including [Emim][Ac], water, and cellulose forms following dissolution of biomass in the IL and subsequent addition of an aqueous concentrated phosphate solution. This process partially separates lignin from the cellulose in Miscanthus, and significantly enhances the rate of hydrolysis of the precipitated cellulose.

The hydrolysis time course data demonstrate that the IL pretreatment process can impact the rate and final conversion of biomass-derived cellulose to glucose. The K₃PO₄ solution causes a phase separation that decreases the water that must be evaporated before the IL can be recycled, and also provides an alkaline pretreatment of the substrate. This effect is more pronounced on Miscanthus than it is on Avicel. The basicity of the K₃PO₄ solution presumably results in partial cleavage of lignin, allowing it to remain soluble in the IL. Without being bound by any theory, this scenario is supported by the slower rates of hydrolysis of samples precipitated with K₂HPO₄, which causes a phase separation but is not as basic. This pretreatment method removes the physical barrier that results from lignin occlusion of the holocellulose and reduces the opportunity for unproductive binding of cellulolytic enzymes to the lignin that occurs with other pretreatment approaches. The presence of lignin in the IL may affect pretreatment with recycled IL. Removal of the lignin from the IL may be necessary to prolong the lifetime of the recycled IL, and affords an opportunity to convert the lignin into higher value products.

The overall IL recovery which includes the washing method, separation method, and removal of the remaining water, may be optimized further. Separation of the IL, precipitate, and aqueous phases can be attempted by various methods other than centrifugation, including filtration and decanting. Removal of the remaining water from the IL phase is desirable, as its presence may affect the ability of the recycled ionic liquid to solubilize fresh biomass (FIG. 6). The recovery of hemicellulose also is desirable, since this is also a valuable sugar source. Much of the hemicellulose is removed in the washing steps, and optimizing these steps will allow the entire sugar content of the biomass to be captured. However, the present work provides a means to recover and recycle ILs used to pretreat biomass without large energy input, and the process can be further developed to provide a co-product stream of lignin.

### REFERENCES

1. Blanch, H. W. and C. R. Wilke, Sugars and chemicals from cellulose. Rev. Chem. Eng, 1982. 1: p. 71-119.
2. da Costa, L., et al., “Cradle to Grave” assessment of existing lignocellulose pretreatment technologies. Current Opinion in Biotechnology, 2009. 20: p. 339-347.
3. Lau, M. W. and B. E. Dale, Cellulosic ethanol production from AFEX-treated corn stover using Saccharomyces cerevisiae 424A(LNH-ST). Proc Natl Acad Sci USA, 2009. 106(5): p. 1368-73.
4. Fort, D. A., et al., Can ionic liquids dissolve wood? Processing and analysis of lignocellulosic materials with 1-n-butyl-3-methylimidazolium chloride. Green Chemistry, 2007. 9(1): p. 63.
5. Zavrel, M., et al., High-throughput screening for ionic liquids dissolving (ligno-)cellulose. Bioresour Technol, 2009. 100(9): p. 2580-7.
6. Kilpeläinen, I., et al., Dissolution of wood in ionic liquids. J Agric Food Chem, 2007. 55(22): p. 9142-8.
7. Fukaya, Y., et al., Cellulose dissolution with polar ionic liquids under mild conditions: required factors for anions. Green Chemistry, 2008. 10(1): p. 44-46.
8. Zhang, H., et al., 1-Allyl-3-methylimidazolium chloride room temperature ionic liquid: A new and powerful nonderivatizing solvent for cellulose. Macromolecules, 2005. 38(20): p. 8272-8277.
9. Zhu, S., et al., Dissolution of cellulose with ionic liquids and its application: a mini-review. Green Chemistry, 2006. 8(4): p. 325-327.
10. Remsing, R. C., et al., Mechanism of cellulose dissolution in the ionic liquid 1-n-butyl-3-methylimidazolium chloride: a 13C and 35/37Cl NMR relaxation study on model systems. Chem Commun (Camb), 2006(12): p. 1271-3.
11. Swatloski, R. P., et al., Dissolution of cellulose with ionic liquids. J Am Chem Soc, 2002. 124(18): p. 4974-5.
12. Sun, N., et al., Complete dissolution and partial delignification of wood in the ionic liquid 1-ethyl-3-methylimidazolium acetate. Green Chem., 2009. 11: p. 646.
13. Pu, Y., N. Jiang, and A. J. Ragauskas, Ionic liquid as a green solvent for lignin. Journal of Wood Chemistry and Technology, 2007. 27(1): p. 23-33.
14. Lee, S. H., et al., Ionic liquid-mediated selective extraction of lignin from wood leading to enhanced enzymatic cellulose hydrolysis. Biotechnol Bioeng, 2009. 102(5): p. 1368-76.
15. Tan, S. S. Y., et al., Extraction of lignin from lignocellulose at atmospheric pressure using alkylbenzenesulfonate ionic liquid. Green Chemistry, 2009. 11(3): p. 339-345.
16. Dadi, A. P., S. Varanasi, and C. A. Schall, Enhancement of cellulose saccharification kinetics using an ionic liquid pretreatment step. Biotechnol Bioeng, 2006. 95(5): p. 904-10.
17. Dadi, A. P., C. A. Schall, and S. Varanasi, Mitigation of cellulose recalcitrance to enzymatic hydrolysis by ionic liquid pretreatment. Appl Biochem Biotechnol, 2007. 137-140(1-12): p. 407-21.
18. Zhao, H., et al., Designing enzyme-compatible ionic liquids that can dissolve carbohydrates. Green Chemistry, 2008. 10(6): p. 696-705.
19. Zhao, H., et al., Regenerating cellulose from ionic liquids for an accelerated enzymatic hydrolysis. J Biotechnol, 2009. 139(1): p. 47-54.
20. Gutowski, K. E., et al., Controlling the aqueous miscibility of ionic liquids: aqueous biphasic systems of water-miscible ionic liquids and water-structuring salts for recycle, metathesis, and separations. J Am Chem Soc, 2003. 125(22): p. 6632-3.
21. Bridges, N. J., K. E. Gutowski, and R. D. Rogers, Investigation of aqueous biphasic systems formed from solutions of chaotropic salts with kosmotropic salts (salt-salt-ABS). Green Chem., 2007. 52: p. 177-183.
22. Pei, Y. C., et al., Liquid-liquid equilibria of aqueous biphasic systems containing selected imidazolium ionic liquids and salts. J. Chem. Eng. Data, 2007. 52: p. 2026-2031.
23. Wu, B., Y. M. Zhang, and H. P. Wang, Phase behaviour for ternary systems composed of ionic liquid+saccharides+water. J. Phys. Chem. B, 2008. 112: p. 6426-6429.
24. Deng, Y., et al., Phase Diagram of [Amim] Cl+ Salt Aqueous Biphasic Systems and Its Application for [Amim] Cl Recovery. Journal of Chemical & Engineering Data, 2009: p. 64-82.
25. Deng, Y., D. Zhang, and J. Chen, Phase diagram data for several salt+salt aqueous biphasic systems at 298.15K J. Chem. Eng. Data, 2007. 52: p. 1332-1335.
26. Neves, C. M. S. S., et al., Evaluation of cation influence on the formation and extraction capability of ionic-liquid-based aqueous biphasic systems. J Phys Chem B, 2009. 113(15): p. 5194-9.
27. Ventura, S. P. M., et al., Evaluation of anion influence on the formation and extraction capacity of ionic-liquid-based aqueous biphasic systems. J Phys Chem B, 2009. 113(27): p. 9304-10.
28. Ghose, T. K., Measurement of Cellulase Activities. Pure & Appl. Chem., 1987. 59(2): p. 257-68.

### ENUMERATED EMBODIMENTS

The following enumerated embodiments are representative of some aspects of the invention.

1. A composition comprising:

(a) biomass;

(b) an ionic liquid;

(c) water; and

(d) a salt comprising a kosmotropic anion selected from the group consisting of phosphate, hydrogenphosphate, sulfate, ethylsulfate, borate, bromide, chloride, acetate, formate, citrate, and mixtures thereof.

2. The composition of embodiment 1, wherein the salt further comprises a cation selected from one or more of the group consisting of a Group IA metal, a Group IIA metal, a transition metal, and ammonium.

3. The composition of embodiment 2, wherein the cation is selected from one or more of the group consisting of lithium, sodium, potassium, magnesium, calcium, and ammonium.

4. The composition of any of embodiments 1-3, wherein the salt is potassium phosphate or potassium hydrogenphosphate.

5. The composition of any of embodiments 1-4, wherein the ionic liquid comprises an ionic liquid cation, and wherein the ionic liquid cation is selected from the group consisting of optionally substituted imidazolium; optionally substituted pyridinium; optionally substituted pyridazinium; optionally substituted pyrimidinium; optionally substituted pyrazinium; optionally substituted pyrazolium; optionally substituted thiazolium; optionally substituted 1,2,3-triazolium; optionally substituted 1,2,4-triazolium; optionally substituted oxazolium; optionally substituted isoquinolinium; optionally substituted quinolinium; optionally substituted pyrrolidinium; optionally substituted piperidinium; and mixtures thereof.

6. The composition of embodiment 5, wherein the ionic liquid cation is optionally substituted imidazolium or optionally substituted pyridinium.

7. The composition of any of embodiments 1-6, wherein the ionic liquid comprises an ionic liquid anion, and wherein the ionic liquid anion is selected from the group consisting of halide, lactate, acetate, perchlorate, tetrafluoroborate, hexafluorophosphate, hexafluoroantimonate, nitrite, nitrate, sulfate, phosphate, hydrogenphosphate, triflate, carbonate, C2-C6 carboxylate, and mixtures thereof.

8. The composition of embodiment 7, wherein the ionic liquid anion is selected from one or more of the group consisting of halide, lactate, and acetate.

9. The composition of embodiment 8, wherein the ionic liquid anion is acetate.

10. The composition of any of embodiments 1-9, wherein the ionic liquid is a 1,3-dialkylated imidazolium salt:

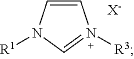

wherein each R1 and R3 are independently selected from the group consisting of optionally substituted C1-C6 alkyl and unsubstituted C1-C6 alkyl.

11. The composition of embodiment 10, wherein each R1 and R3 are independently selected from the group consisting of methyl, ethyl, propyl, isopropyl, butyl, isobutyl, and tert-butyl.

12. The composition of any of embodiments 1-11, wherein the ionic liquid is 1-ethyl-3-methylimidazolium acetate or 1-butyl-3-methylimidazolium acetate and the salt is K3PO4 or K2HPO4.

13. The composition of embodiment 12, wherein the ionic liquid is 1-ethyl-3-methylimidazolium acetate and the salt is K3PO4.

14. The composition of any of embodiments 1-13, wherein the composition comprises an aqueous phase and an ionic liquid phase.

15. The composition of embodiment 14, wherein the aqueous phase comprises 0-2 wt % of the ionic liquid.

16. The composition of embodiment 14, wherein the aqueous phase comprises 0-1 wt % of the ionic liquid.

17. The composition of embodiment 14, wherein the aqueous phase comprises 0-0.5 wt % of the ionic liquid.

18. The composition of any of embodiments 14-17, wherein the aqueous phase comprises 20-60 wt % of the salt.

19. The composition of embodiment 14-17, wherein the aqueous phase comprises 30-50 wt % of the salt.

20. The composition of embodiment 14-17, wherein the aqueous phase comprises 35-45 wt % of the salt.

21. A method of pretreating biomass comprising:

(a) combining the biomass with an ionic liquid to form a first composition;

(b) heating the first composition to form a pretreated biomass composition;

(c) contacting a salt comprising a kosmotropic anion in an aqueous solution with the pretreated biomass composition to form an aqueous phase, an ionic liquid phase, and precipitated solids, wherein the aqueous phase comprises 0-2 wt % of the ionic liquid; and

(d) separating the aqueous phase, the ionic liquid phase, and the precipitated solids.

22. The method of embodiment 21, further comprising:

(e) recycling the ionic liquid phase in a subsequent pretreatment.

23. The method of embodiment 21, wherein the aqueous phase comprises 0-1 wt % of the ionic liquid.

24. The method of embodiment 21, wherein the aqueous phase comprises 0-0.5 wt % of the ionic liquid.

25. The method of embodiment 21, wherein the kosmotropic anion is selected from the group consisting of phosphate, hydrogenphosphate, sulfate, ethylsulfate, borate, bromide, chloride, acetate, formate, citrate, and mixtures thereof.

26. The method of any of embodiments 21-25, wherein the salt further comprises a cation selected from one or more of the group consisting of a Group IA metal, a Group IIA metal, a transition metal, and ammonium.

27. The method of any of embodiments 21-26, wherein the cation is selected from one or more of the group consisting of lithium, sodium, potassium, magnesium, calcium, and ammonium.

28. The method of any of embodiments 21-27, wherein the salt is potassium phosphate or potassium hydrogenphosphate.

29. The method of any of embodiments 21-28, wherein the ionic liquid comprises an ionic liquid cation, and wherein the ionic liquid cation is selected from the group consisting of optionally substituted imidazolium; optionally substituted pyridinium; optionally substituted pyridazinium; optionally substituted pyrimidinium; optionally substituted pyrazinium; optionally substituted pyrazolium; optionally substituted thiazolium; optionally substituted 1,2,3-triazolium; optionally substituted 1,2,4-triazolium; optionally substituted oxazolium; optionally substituted isoquinolinium; optionally substituted quinolinium; optionally substituted pyrrolidinium; optionally substituted piperidinium; and mixtures thereof.

30. The method of any of embodiments 21-29, wherein the ionic liquid cation is optionally substituted imidazolium or optionally substituted pyridinium.

31. The method of any of embodiments 21-30, wherein the ionic liquid comprises an ionic liquid anion, and wherein the ionic liquid anion is selected from the group consisting of halide, lactate, acetate, perchlorate, tetrafluoroborate, hexafluorophosphate, hexafluoroantimonate, nitrite, nitrate, sulfate, phosphate, hydrogenphosphate, triflate, carbonate, C2-C6 carboxylate, and mixtures thereof.

32. The method of any of embodiments 21-31, wherein the ionic liquid anion is selected from one of more of the group consisting of halide, lactate, and acetate.

33. The method of embodiment 32, wherein the ionic liquid anion is acetate.

34. The method of any of embodiments 21-33, wherein the ionic liquid is a 1,3-dialkylated imidazolium salt:

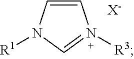

wherein each R1 and R3 are independently selected from the group consisting of optionally substituted C1-C6 alkyl and unsubstituted C1-C6 alkyl.

35. The method of embodiment 34, wherein each R1 and R3 are independently selected from the group consisting of methyl, ethyl, propyl, isopropyl, butyl, isobutyl, and tert-butyl.

36. The method of any of embodiments 21-35, wherein the ionic liquid is 1-ethyl-3-methylimidazolium acetate or 1-butyl-3-methylimidazolium acetate and the salt is K3PO4 or K2HPO4.

37. The method of embodiment 36, wherein the ionic liquid is 1-ethyl-3-methylimidazolium acetate and the salt is K3PO4.

38. The method of any of embodiments 21-37, wherein the heating is carried out at a temperature of 100-180° C.

39. The method of embodiment 38, wherein the heating is carried out at a temperature of 120-160° C.

40. The method of either embodiment 38 or 39, wherein the heating is carried out at a temperature of 130-150° C.

41. The method of any of embodiments 21-40, further comprising providing conditions for enzymatic hydrolysis of the precipitated solids.

42. The method of any of embodiments 21-41, wherein the enzymatic hydrolysis is carried out with cellulase enzymes.

43. The method of any of embodiments 21-42, further comprising cooling the pretreated biomass composition prior to the contacting step.

44. The method of any of embodiments 21-43, wherein 85-100% of the ionic liquid is recovered after separation from the precipitated solids and the aqueous phase.

45. The method of any of embodiments 21-44, wherein 90-100% of the ionic liquid is recovered after separation from the precipitated solids and the aqueous phase.

46. The method of any of embodiments 21-45, wherein 95-100% of the ionic liquid is recovered after separation from the precipitated solids and the aqueous phase.

47. The method of any of embodiments 21-46, wherein the biomass comprises lignin and cellulose, and wherein the precipitated solids comprise cellulosic material wherein at least 50% of the lignin originally present has been removed.

48. The method of any of embodiments 21-47, wherein the aqueous phase comprises 20-60 wt % of the salt.

49. The method of embodiment 21-47, wherein the aqueous phase comprises 30-50 wt % of the salt.

50. The method of embodiment 21-47, wherein the aqueous phase comprises 35-45 wt % of the salt.

1. A composition comprising:
(a) biomass;
(b) an ionic liquid;
(c) water; and
(d) a salt comprising a kosmotropic anion selected from the group consisting of phosphate, hydrogenphosphate, sulfate, ethylsulfate, borate, bromide, chloride, acetate, formate, citrate, and mixtures thereof.

2. (canceled)

3. (canceled)

4. The composition of claim 1, wherein the salt is potassium phosphate or potassium hydrogenphosphate.

5. The composition of claim 1, wherein the ionic liquid comprises an ionic liquid cation, and wherein the ionic liquid cation is selected from the group consisting of optionally substituted imidazolium; optionally substituted pyridinium; optionally substituted pyridazinium; optionally substituted pyrimidinium; optionally substituted pyrazinium; optionally substituted pyrazolium; optionally substituted thiazolium; optionally substituted 1,2,3-triazolium; optionally substituted 1,2,4-triazolium; optionally substituted oxazolium; optionally substituted isoquinolinium; optionally substituted quinolinium; optionally substituted pyrrolidinium; optionally substituted piperidinium; and mixtures thereof.

6. The composition of claim 1, wherein the ionic liquid comprises an ionic liquid cation, and wherein the ionic liquid cation is optionally substituted imidazolium or optionally substituted pyridinium.

7. The composition of claim 1, wherein the ionic liquid comprises an ionic liquid anion, and wherein the ionic liquid anion is selected from the group consisting of halide, lactate, acetate, perchlorate, tetrafluoroborate, hexafluorophosphate, hexafluoroantimonate, nitrite, nitrate, sulfate, phosphate, hydrogenphosphate, triflate, carbonate, C₂-C₆ carboxylate, and mixtures thereof.

8. (canceled)

9. The composition of claim 1, wherein the ionic liquid comprises an ionic liquid anion, and wherein the ionic liquid anion is acetate.

10. The composition of claim 1, wherein the ionic liquid is a 1,3-dialkylated imidazolium salt: 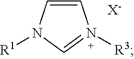
wherein each R¹ and R³ are independently selected from the group consisting of optionally substituted C1-C6 alkyl and unsubstituted C1-C6 alkyl.

11. (canceled)

12. The composition of claim 1, wherein the ionic liquid is 1-ethyl-3-methylimidazolium acetate or 1-butyl-3-methylimidazolium acetate and the salt is K₃PO₄ or K₂HPO₄.

13. (canceled)

14. (canceled)

15. (canceled)

16. (canceled)

17. (canceled)

18. (canceled)

19. (canceled)

20. (canceled)

21. A method of pretreating biomass comprising:
(a) combining the biomass with an ionic liquid to form a first composition;
(b) heating the first composition to form a pretreated biomass composition;
(c) contacting a salt comprising a kosmotropic anion in an aqueous solution with the pretreated biomass composition to form an aqueous phase, an ionic liquid phase, and precipitated solids, wherein the aqueous phase comprises wt % of the ionic liquid; and
(d) separating the aqueous phase, the ionic liquid phase, and the precipitated solids.

22. (canceled)

23. (canceled)

24. (canceled)

25. The method of claim 21, wherein the kosmotropic anion is selected from the group consisting of phosphate, hydrogenphosphate, sulfate, ethylsulfate, borate, bromide, chloride, acetate, formate, citrate, and mixtures thereof.

26. (canceled)

27. (canceled)

28. The method of claim 21, wherein the salt is potassium phosphate or potassium hydrogenphosphate.

29. The method of claim 21, wherein the ionic liquid comprises an ionic liquid cation, and wherein the ionic liquid cation is selected from the group consisting of optionally substituted imidazolium; optionally substituted pyridinium; optionally substituted pyridazinium; optionally substituted pyrimidinium; optionally substituted pyrazinium; optionally substituted pyrazolium; optionally substituted thiazolium; optionally substituted 1,2,3-triazolium; optionally substituted 1,2,4-triazolium; optionally substituted oxazolium; optionally substituted isoquinolinium; optionally substituted quinolinium; optionally substituted pyrrolidinium; optionally substituted piperidinium; and mixtures thereof.

30. The method of claim 21, wherein the ionic liquid comprises an ionic liquid cation, and wherein the ionic liquid cation is optionally substituted imidazolium or optionally substituted pyridinium.

31. The method of claim 21, wherein the ionic liquid comprises an ionic liquid anion, and wherein the ionic liquid anion is selected from the group consisting of halide, lactate, acetate, perchlorate, tetrafluoroborate, hexafluorophosphate, hexafluoroantimonate, nitrite, nitrate, sulfate, phosphate, hydrogenphosphate, triflate, carbonate, C₂-C₆ carboxylate, and mixtures thereof.

32. (canceled)

33. The method of claim 21, wherein the ionic liquid comprises an ionic liquid anion, and wherein the ionic liquid anion is acetate.

34. The method of claim 21, wherein the ionic liquid is a 1,3-dialkylated imidazolium salt: 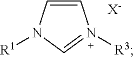
wherein each R¹ and R³ are independently selected from the group consisting of optionally substituted C1-C6 alkyl and unsubstituted C1-C6 alkyl.

35. (canceled)

36. The method of claim 21, wherein the ionic liquid is 1-ethyl-3-methylimidazolium acetate or 1-butyl-3-methylimidazolium acetate and the salt is K₃PO₄ or K₂HPO₄.

37. (canceled)

38. The method of claim 21, wherein the heating is carried out at a temperature of 100-180° C.

39. (canceled)

40. (canceled)

41. The method of claim 21, further comprising providing conditions for enzymatic hydrolysis of the precipitated solids.

42. (canceled)

43. (canceled)

44. (canceled)

45. (canceled)

46. (canceled)

47. The method of claim 21, wherein the biomass comprises lignin and cellulose, and wherein the precipitated solids comprise cellulosic material wherein at least 50% of the lignin originally present has been removed.

48. (canceled)

49. (canceled)

50. (canceled)
